(19) United States
(12) Patent Application Publication
(10) Pub. No.: US 2019/0126852 A1
(43) Pub. Date: May 2, 2019

(54) SEPARATING WALL DEVICE AND METHOD FOR PRODUCING A SEPARATING WALL DEVICE

(71) Applicant: E. I. S. Aircraft GmbH, Euskirchen (DE)

(72) Inventors: Gerold Karl HUPPERICH, Dahlem (DE); Sven ACHILLES, Michelfeld (DE); Thomas STURM, Zehnhausen (DE)

(21) Appl. No.: 16/089,566

(22) PCT Filed: Mar. 31, 2017
(86) PCT No.: PCT/EP2017/057652

§ 371 Date: Sep. 28, 2018

(30) Foreign Application Priority Data
Mar. 31, 2016 (DE) 10 2016 105 893.9

(51) Int. Cl. B60R 13/00; B64D 11/00

(52) U.S. Cl. CPC B60R 13/00; B64D 2011/0046; B64D 11/00

(57) ABSTRACT

A separating wall device, in particular for a vehicle, comprises at least one frame unit defining, at least in a mounted state, at least one separating unit accommodation region, and comprising at least one frame section. Viewed along a frame middle line that extends in the frame section and along the frame section, the frame section has at least two frame cross sections, which are substantially different from each other.

### STATE OF THE ART

The invention is based on a separating wall device according to the preamble of claim 1 and on a method for producing a separating wall device according to the preamble of claim 14.

From DE 10 2009 010 861 A1 a separating wall device for an aircraft is known, with a frame unit for an accommodation of a separating unit, wherein the frame unit is built from equiform beam components.

The objective of the invention is in particular to provide a generic separating wall device having improved characteristics regarding flexibility. The objective is achieved by the characterizing features of claims 1, 5 and 14 while advantageous implementations and further developments of the invention may be gathered from the subclaims.

### Advantages of the Invention

The invention is based on a separating wall device, in particular for a vehicle, with at least one frame unit defining, at least in a mounted state, at least one separating unit accommodation region, which is in particular configured to accommodate at least one separating unit, and comprising at least one frame section.

It is proposed that, viewed along a frame middle line that extends, in particular continuously, in the frame section and along the frame section, the frame section has at least two frame cross sections, advantageously at least three, preferably at least four and particularly preferably at least five frame cross sections, which are in particular offset in the direction of the frame middle line, which are in particular arranged perpendicularly to the frame middle line and which are substantially different from each other. “Configured” is in particular to mean specifically designed and/or equipped. By an object being configured for a certain function is in particular to be understood that the object fulfills and/or carries out said certain function in at least one application state and/or operating state.

A “separating wall device” is in particular to mean, in this context, at least a part, in particular a sub-assembly group, of a separating wall. It is in particular also possible that the separating wall device comprises the entire separating wall. Herein the separating wall device is advantageously, in particular specifically, configured for a usage in a vehicle, advantageously in a vehicle cabin of the vehicle. In particular, the separating wall may herein also be realized as part of a stowage space unit, in particular of a cupboard, of a luggage rack and/or of a kitchen segment. The vehicle ma herein be implemented as any kind of vehicle, in particular as a land craft like, for example, as a rail vehicle and/or an automotive vehicle, as a watercraft and/or advantageously as an aircraft like, for example, as a passenger plane, a transport plane, a glider plane, an helicopter and/or an airship.

Furthermore, a “frame unit” is in particular to be understood as a unit which implements a structure, in particular frame structure, that is in particular at least partly load-bearing, and which is in particular configured for an accommodation, holding, fixation and/or guidance of at least one object, in particular of at least one separating unit, while encompassing and/or enclosing in particular the object, in particular the separating unit, at least partly, preferably at least to a large extent and particularly preferably completely. For this purpose the frame unit in particular comprises at least one frame element, advantageously side frame element and/or transverse frame element, which is preferentially at least partly beam-shaped. The frame element may herein be embodied as a hollow profile and/or as a full profile. Advantageously the frame unit differs from a support structure of the vehicle like, for example, a bottom, a ceiling, a side wall, a luggage rack and/or any further structural component of the vehicle. The frame unit may in particular also be implemented in a modular structure and may preferably comprise a plurality of frame elements, which are in particular capable of being plugged together. Preferentially the frame unit is implemented at least partly, preferably at least to a large extent and especially preferentially completely, of a synthetic material, of a metal, in particular steel, titanium and/or aluminum, and/or of a composite material, advantageously a fiber composite material and particularly preferably a synthetic fiber composite material like, for example, a carbon fiber reinforced synthetic material, a mineral fiber reinforced synthetic material, an aramid fiber reinforced synthetic material, a ceramic fiber reinforced and/or advantageously a glass fiber reinforced synthetic material, advantageously a thermoplastic material. In particular, the frame unit may as well be implemented at least partly, preferably at least to a large extent and particularly preferably completely, of an austenitic stainless aircraft construction material. The term “at least to a large extent” is herein in particular to mean by at least 55%, advantageously by at least 65%, preferentially by at least 75%, especially preferentially by at least 85% and particularly advantageously by at least 95%. Furthermore, a “frame section” is in particular to mean at least a portion of the frame unit. Advantageously the frame section is herein arranged in a region that is different from a corner region of the frame unit. It is in particular also possible that the frame section is equivalent to the entire frame unit. Further, a “frame middle line” is in particular to mean a line, in particular a hypothetical line, that follows and/or describes a contour of the frame section and in particular extends centrally through the frame section. In particular, the frame middle line herein extends through at least a center point, in particular geometrical center point, of any frame cross section of the frame unit, which is in particular arranged perpendicularly to the frame middle line. Advantageously the frame middle line extends through each center point, in particular geometrical center point, of each frame cross section of the frame unit, which is in particular arranged perpendicularly to the frame middle line. The frame middle line is herein advantageously arranged in such a way that a perpendicular distance of the frame middle line to opposite-situated delimiting walls, in particular outer and/or inner delimiting walls, of the frame unit is the same, in particular in any point. Moreover a frame cross section of the frame unit, which is in particular arranged perpendicularly to the frame middle line, may have any shape and/or contour, e.g. oval, ellipse-shaped, circle-shaped, triangular, tetragonal, hexagonal, octagonal, star-shaped and/or cross-shaped. The term that two objects are “substantially different” from one another is in particular to mean that a contour, a shape, a relative orientation and/or at least one extension length of the objects, advantageously in a direction of the frame middle line, in particular viewed in at least one direction, advantageously in a direction of the frame middle line, differ from one another by at least 5%, advantageously by at least 10%, preferably by at least 15%, especially advantageously by at least 20% and particularly preferably by at least 25%, in particular by an area portion, by a length portion and/or by a relative orientation. This implementation allows providing a separating wall device having improved characteristics regarding flexibility, in particular flexibility in terms of design. Moreover, it is advantageously possible to increase a stability and/or to reduce a weight of the separating wall device. Furthermore an efficiency, in particular an efficiency regarding structural components, regarding construction space, regarding assembly and/or regarding costs, is advantageously improvable.

The frame cross sections preferably have substantially different outer diameters. An “outer diameter” of a frame cross section is in particular to mean, in this context, a diameter of a smallest, in particular imaginary, circle just still entirely encompassing the frame cross section and in particular just touching an outer delimiting wall of the frame unit. Advantageously the frame sections, which are in particular substantially different, herein have a same outer shape and/or outer contour and advantageously differ only by an, in particular outer, extension length. This allows adapting the frame unit and/or the frame section to different requirements in an advantageously simple and/or cost-efficient manner.

It is furthermore proposed that the frame cross sections have substantially different inner diameters. An “inner diameter” of a frame cross section is here in particular to mean a diameter of a largest, in particular imaginary, circle that is arrangeable in a center of the frame cross section and just touches the frame cross section, in particular an inner delimiting wall of the frame unit. In particular, the frame section is in this case embodied at least partially as a hollow profile and comprises a centrally arranged recess. Advantageously the, in particular substantially different, frame sections have a same inner shape and/or inner contour and advantageously differ only by an, in particular inner, extension length. In this way it is in particular advantageously possible to augment stability, in particular without changing an outer dimensioning of the frame unit. Moreover a construction space efficiency and/or a weight of the frame unit are/is advantageously optimizable.

It is also proposed that the frame cross sections have substantially different maximum and/or minimum wall thicknesses, as a result of which in particular an advantageous adaption of the frame unit is achievable.

According to a further aspect of the invention, which is in particular realizable on its own or advantageously in addition to the mentioned aspects of the invention, and which is preferably combinable with at least some, advantageously at least a large portion and preferably all of the mentioned aspects, a separating wall device, in particular for a vehicle, is proposed, with at least one frame unit defining, at least in a mounted state, at least one separating unit accommodation region, which is in particular configured to accommodate at least one separating unit, and comprising at least one frame section, wherein, viewed at least in a direction that is parallel to a main extension plane of the separating unit accommodation region and advantageously viewed in parallel to a ground and/or bottom, in particular of the vehicle, the frame section has a course that differs from a straight course, in particular a curved and/or bent course. This in particular allows achieving the advantages mentioned above. In particular, a suitable implementation allows providing a separating wall device with improved characteristics regarding flexibility, in particular flexibility in terms of design. It is moreover advantageously possible to increase a stability and/or to reduce a weight of the separating wall device. Beyond this an efficiency, in particular an efficiency regarding structural components, regarding construction space, regarding assembly and/or regarding costs, is advantageously improvable. By a “main extension plane” of an object is herein in particular a plane to be understood which is parallel to a largest side area of a smallest, in particular imaginary, rectangular cuboid just still entirely enclosing the object, and which in particular extends through a center point, in particular a geometrical center point, of the rectangular cuboid.

An especially high degree of stability is in particular achievable if the frame section is embodied in a one-part implementation. “Embodied in a one-part implementation” is in particular to mean, in this context, at least connected by substance-to-substance bond and/or implemented integrally with one another. The substance-to-substance bond may be established, for example, by a gluing process, an injection-molding process, a welding process, a soldering process and/or by another type of process. Advantageously “embodied in a one-part implementation” is to mean formed of one piece and/or in one piece. This one piece is preferably produced of one single blank, one mass and/or one cast, for example in an extrusion procedure, in particular a one-component and/or multi-component extrusion procedure, and/or in an injection molding procedure, in particular a one-component and/or multi-component injection molding procedure.

It is further proposed that the frame unit comprises at least one side frame element, which is in a mounted state arranged at least substantially vertically, and comprises at least one transverse frame element, which is arranged at least substantially perpendicularly to the side frame element, wherein the frame section is, in particular entirely, arranged in the side frame element. In this context, a “side frame element which is arranged at least substantially vertically” is in particular to be understood as a side frame element which is, at least section-wise, arranged at least substantially vertically. By the term “at least substantially vertically” is herein in particular a direction to be understood which includes an angle of maximally 8°, preferentially maximally 5° and especially preferentially maximally 2° with a vertical direction and/or vertical reference direction, which is in particular arranged in a same plane. By a “vertically arranged side frame element” is in particular a side frame element to be understood which, in a mounted state, extends in a vertical direction. A “vertical direction” is herein in particular to mean a height direction and/or a direction that is, in a mounted state, arranged perpendicularly to a ground and/or bottom, in particular of the vehicle. Furthermore, the term “at least substantially perpendicularly” is in particular to define an orientation of a direction relative to a reference direction, wherein the direction and the reference direction, in particular viewed in a plane, include an angle which is in particular between 82° and 98°, advantageously between 85° and 95° and particularly preferably between 88° and 92°. Preferentially the frame unit herein comprises at least two, in particular opposite-situated, side frame elements and/or at least two, in particular opposite-situated, transverse frame elements. Beyond this the frame unit advantageously comprises at least one frame element, in particular transverse frame element, which is embodied as a foot rest. Alternatively or additionally it is however also conceivable that the frame section is, in particular completely, arranged in a transverse frame element. This in particular allows optimizing stability and/or space-usage.

It is also proposed that the frame unit, in particular at least the frame section, has at least section-wise a multi-layer structure with at least two, advantageously at least three layers, which are advantageously implemented, at least to a large extent, of different materials. In this way in particular an advantageous flexibility and/or stability are/is achievable. Moreover a diversity of designs is advantageously augmentable.

In a preferred implementation of the invention it is proposed that the frame section is in a mounted state arranged in a region of the frame unit that is near a bottom. By a “region that is near a bottom” is in particular, in this context, a proximity region of a bottom, in particular of the vehicle, to be understood. By a “proximity region” is in particular a spatial region to be understood which is implemented of points having a distance of less than 50%, advantageously less than 40% and particularly preferably less than 30% of a main extension length, advantageously of a vertical extension length, of the frame unit from a reference point and/or a reference component, in particular the bottom, and/or respectively having a distance of maximally 120 cm, advantageously no more than 100 cm, preferentially maximally 80 cm and especially preferentially no more than 60 cm from a reference point and/or a reference component, in particular the bottom. A “vertical extension length” of an object is in particular to mean, in this context, an extension length of the object in a vertical direction, advantageously a height of the object. In this way in particular space usage is optimizable and/or an advantageous leg space is achievable.

Furthermore it is proposed that the separating wall device comprises at least one separating unit, which is arranged in the separating unit accommodation region and advantageously is flexibly adaptable and/or has a modular structure, wherein the frame unit is configured to absorb at least a large portion of a weight force of the separating unit and/or of dynamic forces of the separating unit, e.g. acceleration forces, in particular during operation of the vehicle, and/or forces acting from an outside, e.g. push forces, and/or to introduce, in particular in a mounted state, a large portion of a weight force of the separating unit and/or of dynamic forces of the separating unit, e.g. acceleration forces, in particular during operation of the vehicle, and/or forces acting from an outside, e.g. push forces, into at least one support structure of the vehicle like, for example, a bottom, a ceiling, a side wall, a luggage rack and/or any further structural component of the vehicle. By a “separating unit” is herein in particular a unit, advantageously a, preferably large area, upper surface unit to be understood, which is in particular configured to at least partly separate at least two regions from one another and/or separating off at least two region In particular, the separating unit is herein configured at least for a space division and advantageously for a visual separation. Preferentially the separating unit comprises at least one functional unit accommodation region for at least one functional unit, which is advantageously exchangeable and/or replaceable. The at least one functional unit accommodation region and/or the at least one functional unit may herein be implemented, for example, as a literature holder, as an electronics unit holder, as a holder for a baby bassinet, as a deposit unit, as a display unit, as an entertainment unit, as a predetermined-break structure and/or as a lighting unit or the like. In particular, the separating unit may also comprise the at least one functional unit. Especially advantageously the separating unit comprises a plurality of functional unit accommodation regions for a plurality of, in particular different, functional units, and/or a plurality of different functional units. This in particular allows achieving an advantageous space division. It is advantageously further possible to improve construction space efficiency and/or to increase a user-friendliness.

If the frame unit comprises, on a side facing towards the separating unit, at least one fixation unit, which is configured at least for a form-fit fixation of the separating unit, in particular an advantageously stable connection between the frame unit and the separating unit is achievable. Moreover, an advantageously easy and/or quick assembly of the separating wall device is achievable.

In a particularly preferred implementation of the invention it is proposed that a vertical extension length of the separating unit is in the mounted state equivalent to at least 30%, advantageously at least 40%, preferentially at least 50% and especially preferentially at least 60%, and/or maximally 95%, preferably no more than 90% and particularly preferably no more than 85% of a vertical extension length of the frame unit. Especially advantageously herein at least a region that is near the bottom is free of the separating unit. In this way it is in particular possible to further optimize a space usage, thus in particular allowing to create an advantageous stowage space.

It is moreover proposed that the separating unit is embodied at least substantially dimensionally stable, as a result of which in particular functional unit accommodation regions of the separating unit may be used for quite heavy objects as well.

Beyond this it is proposed that the separating unit comprises at least one window unit comprising a vision panel that extends over at least 30%, advantageously at least 45%, preferably at least 60% and particularly preferably at least 75% of an upper surface, in particular a main extension surface, of the separating unit, as a result of which it is in particular possible to provide an advantageously large-area field of vision and in particular to comply with safety regulations, in particular in a vehicle that is embodied as an aircraft. Advantageously the vision panel herein extends, in a mounted state, over at least 60%, advantageously at least 70%, preferentially at least 80% and especially preferentially at least 90% of a transverse extension length of the separating unit.

The invention furthermore relates to a method for producing a separating wall device, in particular for a vehicle, wherein the separating wall device comprises at least one frame unit defining, at least in a mounted state, at least one separating unit accommodation region, which is in particular configured to accommodate at least one separating unit, and comprising at least one frame section.

It is proposed that, viewed along a frame middle line that extends in the frame section and along the frame section, the frame section has at least two frame cross sections which are implemented substantially differently from each other. This in particular allows improving a flexibility, in particular a flexibility in terms of a design. It is furthermore advantageously possible to augment a stability and/or to reduce a weight of the separating wall device. Moreover an efficiency, in particular in terms of structural components, of a construction space, of an assembly and/or of costs, is advantageously improvable.

It is also proposed that, for a shaping of the frame unit, in particular during a production of the frame unit, an overpressure of, in particular at least 1 bar, advantageously at least 2 bar and particularly preferably at least 4.5 bar, and/or of maximally 10 bar, advantageously no more than 7.5 bar and particularly preferably maximally 5.5 bar is applied at least to a portion of a pre-product of the frame unit in a container, in particular a pressure container, preferentially an autoclave, said portion or entire pre-product being heated, in particular at a temperature of at least 100° C., advantageously at least 115° C. and especially advantageously at least 140° C., and/or maximally 170° C., advantageously no more than 160° C. and especially advantageously no more than 150° C. In this way it is in particular possible to provide an advantageously stable, flexible and/or cost-efficient frame unit.

The separating wall device and the method for producing the separating wall device are herein not to be limited to the application and implementation described above. In particular, to fulfill a functionality that is described here, the separating wall device and the method for producing the separating wall device may have a number of respective elements, structural components and units that differs from a number that is given here.

### DRAWINGS

Further advantages will become apparent from the following description of the drawings. The drawings show exemplary embodiments of the invention. The drawings, the description and the claims contain a plurality of features in combination. Someone skilled in the art will purposefully also consider the features separately and will find further expedient combinations.

It is shown in:

FIG. 1 a vehicle implemented as an aircraft, with a separating wall device that is not visible and is arranged within the vehicle, in a schematic representation,

FIG. 2 the separating wall device with a frame unit and a separating unit, a schematic representation,

FIG. 3 a fixation unit of the frame unit in a perspective view,

FIG. 4 the frame unit in a schematic sectional side view,

FIG. 5 a first frame cross section of the frame unit in a sectional view corresponding to line V-V in FIGS. 2 and 4,

FIG. 6 a second frame cross section of the frame unit in a sectional view corresponding to line VI-VI in FIGS. 2 and 4,

FIG. 7 a portion of a pre-product for producing the frame unit,

FIG. 8 a container and form tools for producing the frame unit,

FIG. 9 a further separating wall device with a frame unit and a separating unit, in a partial perspective view,

FIG. 10 a first frame cross section of the frame unit of FIG. 9, in a sectional view corresponding to line X-X of FIG. 9,

FIG. 11 a second frame cross section of the frame unit of FIG. 9, in a sectional view corresponding to line XI-XI of FIG. 9,

FIG. 12 a further separating wall device with a frame unit and a separating unit, in a partial perspective view,

FIG. 13 the frame unit of FIG. 12, in a schematic sectional side view,

FIG. 14 a first frame cross section of the frame unit of FIG. 12, in a sectional view corresponding to line XIV-XIV of FIG. 13,

FIG. 15 a second cross section of the frame unit of FIG. 12, in a sectional view corresponding to line XV-XV of FIG. 13,

FIG. 16 a further separating wall device with a modular-structured frame unit, in a perspective view,

FIG. 17 the further separating wall device of FIG. 16 with a separating unit,

FIG. 18 a further exemplary embodiment of a stowage space unit with at least one separating wall device, and

FIG. 19 a further exemplary embodiment of a stowage space unit with at least one separating wall device.

### DESCRIPTION OF THE EXEMPLARY EMBODIMENTS

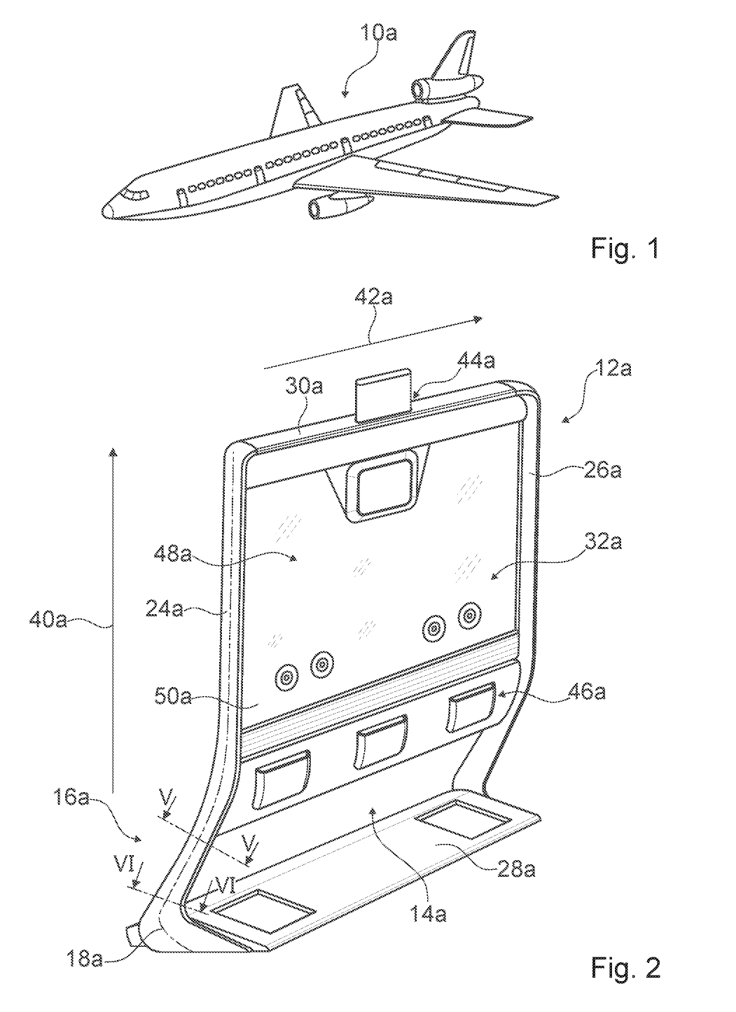

FIG. 1 shows a vehicle 10a, which is exemplarily implemented as an aircraft, in a schematic view. The vehicle 10a is in the present case embodied as a passenger plane. Alternatively it is however also conceivable to implement a vehicle as a transport plane, a glider plane, an helicopter and/or an airship, and/or to implement a vehicle as any vehicle that differs from an aircraft, in particular as a landcraft, e.g. as a rail vehicle and/or motor vehicle, and/or as a watercraft.

The vehicle 10a comprises at least one separating wall device (cf, FIG. 2). The separating wall device is herein implemented as a separating wall device of a vehicle, in the present case in particular as a separating wall device of an aircraft. The separating wall device is implemented as a framework. The separating wall device is configured to be installed within a vehicle cabin of the vehicle 10a, in particular on a bottom of the vehicle cabin of the vehicle 10a. Alternatively it is however also conceivable to suspend a separating wall device within a vehicle cabin of a vehicle, arranging and/or fixating the separating wall device, for example, to a ceiling, to a side wall and/or to a luggage rack. Additionally a separating wall device could also be fixated to a ceiling of the vehicle, in particular for the purpose of increasing stability.

The separating wall device comprises a frame unit 12a. The frame unit 12a is, at least to a large extent, implemented of a synthetic material. The frame unit 12a realizes a load-bearing structure. The frame unit 12a is configured to be fixated on a support structure of the vehicle 10a. The frame unit 12a is different from a support structure of the vehicle 10a.

The frame unit 12a defines a main extension plane. In a perpendicular view of the main extension plane, the frame unit 12a has an at least substantially rectangular shape and/or contour. The frame unit 12a herein comprises, in the present case, two side frame elements 24a, 26a, which are in particular situated opposite each other and spaced apart from each other, and two transverse frame elements 28a, 30a, which are in particular situated opposite each other and spaced apart from each other.

The side frame elements 24a, 26a are in the present case at least substantially identical to one another. Alternatively however, side frame elements could as well be implemented differently from one another, wherein advantageously at least one of the side frame elements could be adapted to a contour of a vehicle cabin and/or could describe a same contour as the vehicle cabin. The side frame elements 24a, 26a are respectively embodied in a one-part implementation. The side frame elements 24a, 26a are embodied as hollow profiles. The side frame elements 24a, 26a are in a mounted state arranged at least substantially vertically, in particular relative to a bottom of the vehicle 10a. A main extension direction of the side frame elements 24a, 26a herein defines a vertical direction 40a.

The transverse frame elements 28a, 30a are in the present case substantially different from one another. The transverse frame elements 28a, 30a are respectively embodied in a one-part implementation. The transverse frame elements 28a, 30a are, in a mounted state, arranged at least substantially perpendicularly to the side frame elements 24a, 26a. In a mounted state, the transverse frame elements 28a, 30a are arranged at least substantially horizontally, in particular relative to a bottom of the vehicle 10a. A main extension direction of the transverse frame elements 28a, 30a herein defines a transverse direction 42a. A first transverse frame element 28a of the transverse frame elements 28a, 30a is embodied as a footrest. In a mounted state, the first transverse frame element 28a is arranged in a region near the bottom. The first transverse frame element 28a is embodied as a hollow profile, in particular a closed hollow profile. The first transverse frame element 28a is in the present case connected to the side frame elements 24a, 26a in a one-part implementation. A second transverse frame element 30a of the transverse frame elements 28a, 30a is embodied as a closing-off element. The second transverse frame element 30a is in a mounted state arranged in a region near a ceiling, in particular in a proximity of a ceiling of the vehicle 10a. The second transverse frame element 30a is embodied as a hollow profile. The second transverse frame element 30a is in the present case connected to the side frame elements 24a, 26a in a one-part implementation.

Alternatively, however, a frame unit could also be realized as a circumferential frame. In this case a footrest might be implemented separately from the frame unit and could be configured for a connection to the frame unit.

The frame unit 12a, in particular the side frame elements 24a, 26a, has in a mounted state a vertical extension length, in particular an extension in the vertical direction 40a, between 100 cm and 200 cm and advantageously between 140 cm and 180 cm. In the present case the frame unit 12a has a vertical extension length, in particular an extension in the vertical direction 40a, of approximately 170 cm. Furthermore, the frame unit 12a, in particular the transverse frame elements 28a, 30a, has/have in a mounted state a transverse extension length, in particular an extension in the transverse direction 42a, which is in particular arranged perpendicularly to the vertical direction 40a, between 60 cm and 250 cm and advantageously between 100 cm and 230 cm. In the present case the frame unit 12a has a transverse extension length, in particular an extension in the transverse direction 42a, of approximately 180 cm.

The frame unit 12a defines, in a mounted state, a separating unit accommodation region 14a. Alternatively a frame unit could also be implemented at least partially of a metal, e.g. steel, titanium and/or aluminum, and/or of a composite material, advantageously a fiber composite material like, for example, a glass-fiber-reinforced synthetic material. A frame unit could as well be implemented, at least partly, of an austenitic stainless aircraft construction material. Furthermore a frame unit could, in a perpendicular view of a main extension plane, have any shape and/or contour differing from a rectangular shape and/or contour like, for example, at least substantially triangular, oval and/or circular, and could advantageously have a shape and/or contour corresponding to a shape and/or contour of a vehicle cabin of a vehicle. It is also conceivable to realize a frame unit with precisely one side frame element and/or precisely one transverse frame element. A frame unit could further comprise any other number of side frame elements and/or transverse frame elements, e.g. at least three, at least four and/or at least five side frame elements and/or transverse frame elements. In this case in particular two of the side frame elements and/or of the transverse frame elements may be implemented as, in particular exterior, delimiting elements, and the further side frame elements and/or transverse frame elements may be implemented as middle elements, advantageously contributing to a stability of the separating wall device. Beyond this it is conceivable to realize transverse frame elements and side frame elements separately from one another, for example connecting them to one another by a force-fit and/or form-fit connection. Herein at least one side frame element and/or transverse frame element could in particular also be embodied in a multi-part implementation.

The separating wall device further comprises a separating unit 32a. The separating unit 32a is embodied at least substantially dimensionally stable. The separating unit 32a is embodied as an upper surface unit. The separating unit 32a defines a further main extension plane. The separating unit 32a has, in a perpendicular view of the further main extension plane, an at least substantially rectangular contour and/or shape, which is in particular implemented in such a way that it corresponds, at least to a large extent, to the shape and/or contour of the frame unit 12a. In the mounted state the separating unit 32a is arranged in the separating unit accommodation region 14a and is in particular configured to at least partially separate at least two regions off from one another. The separating unit 32a thus serves as a space divider.

In a mounted state the separating unit 32a has a vertical extension length, in particular an extension in the vertical direction 40a, which is equivalent to at least 30% and maximally 95% of the vertical extension length of the frame unit 12a. In the present case the vertical extension length of the separating unit 32a is equivalent to approximately 80% of the vertical extension length of the frame unit 12a and thus in particular to approximately 140 cm. A region of the frame unit 12a that is near the bottom is herein free of a separating unit, as a result of which in particular advantageous storage space and/or advantageous leg space are/is achievable. The separating unit 32a moreover has, in the mounted state, a transverse extension length, in particular an extension in the transverse direction 42a, which is at least substantially equivalent to the transverse extension length of the frame unit 12a. In the present case the transverse extension length of the separating unit 32a is equivalent to approximately 95% of the transverse extension length of the frame unit 12a, and thus in particular approximately 142 cm.

The separating unit 32a is furthermore embodied as a non-load-bearing structure. The separating unit 32a is fixated on the frame unit 12a. Herein the frame unit 12a receives at least a large portion of a weight force, of a dynamic force and/or of a force acting from an outside, of the separating unit 32a and transfers said force/s into at least one support structure of the vehicle 10a, in the present case in particular a bottom and a ceiling of the vehicle 10a. Alternatively it is however also conceivable that a force introduction is effected only into a bottom, into a ceiling or into another support structure of a vehicle.

In the present case the separating unit 32a further comprises at least one window unit 48a. The window unit 48a comprises at least one vision panel 50a and serves, in particular, in at least one application state, for a through-view and/or for a viewing of a field of vision that is situated opposite the separating unit 32a. The vision panel 50a herein extends over at least 75% of an upper surface of the separating unit 32a. The vision panel 50a furthermore extends over the entire transverse extension length of the separating unit 32a. In the present case the window unit 48a further comprises a controllable transparency unit (not shown), which is in particular configured in at least one operating state, to at least encumber a through-view through the vision panel 50a, and preferably to prevent the through-view to a large extent. The transparency unit may herein be realized as any kind of, actually already known, transparency unit, for example as polarization sheets and/or as a liquid-crystal film, as has already been described, for example, in document DE 43 19 794 C2, or the like.

Moreover the separating unit 32a is in the present case at least substantially flexibly adaptable, in particular to different requirements. For this purpose the separating unit 32a comprises a plurality of functional unit accommodation regions 44a and/or of functional units 46a. The functional unit accommodation regions 44a and/or functional units 46a may herein be embodied as any kind of objects, e.g. as a literature holder, as an electronics unit holder, as a holder for a baby bassinet, as a deposit unit, as a display unit, as an entertainment unit and/or as a lighting unit. Alternatively a separating unit could also have any other shape and/or contour. A separating unit could moreover be embodied to be at least partly dimensionally flexible, for example with usage of a film and/or textile. It is further conceivable to dispense with a window unit, a transparency unit, a functional unit accommodation region and/or a functional unit. Moreover a separating unit could principally also comprise a plurality of, in particular small-area, window units.

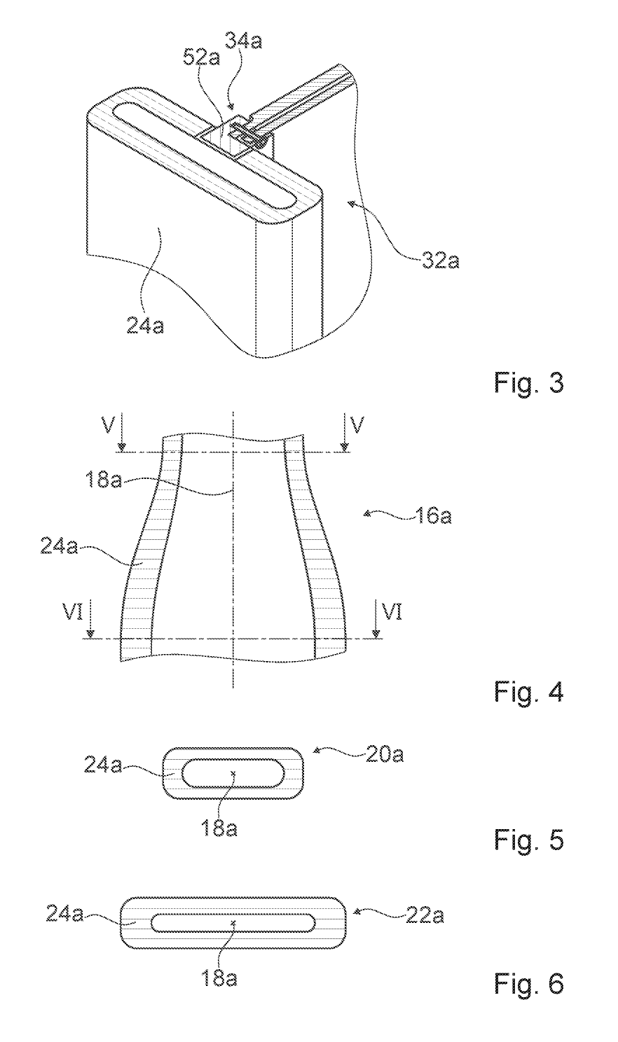

FIG. 3 shows a fixation method for a fixation of the separating unit 32a on the frame unit 12a. For this purpose the frame unit 12a comprises a fixation unit 34a. The fixation unit 34a is arranged on a side of the frame unit 12a that faces toward the separating unit 32a. The fixation unit 34a herein extends, at least to a large extent, around an outer contour of the separating unit 32a. The fixation unit 34a is in the present case configured at least for a form-fit fixation of the separating unit 32a. The fixation unit 34a is moreover configured for a force-fit connection of the separating unit 32a. In the present case, the separating unit 32a is fixated to an, in particular at least substantially L-shaped, connection element 52a of the fixation unit 34a by means of a screw connection, wherein the connection element 52a is in particular connected with the side frame elements 24a, 26a and/or with the second transverse frame element 30a in a force-fit and/or form-fit manner. Alternatively or additionally it is conceivable that a fixation unit is configured for a connection of a separating unit via substance-to-substance bond. It is moreover conceivable to use a connection method that differs from a screw connection, e.g. a clamp connection and/or a latch connection.

In particular for the purpose of augmenting a design flexibility and/or a stability of the frame unit 12a, the frame unit 12a further comprises, in the present case, a frame section 16a which, viewed along a frame middle line 18a that runs in the frame section 16a and along the frame section 16a, comprises at least two frame cross sections 20a, 22a, which are offset in a direction of the frame middle line 18a, which are arranged perpendicularly to the frame middle line 18a and which are substantially different from each other (cf. in particular also FIGS. 4 to 6). In the present case the frame section 16a comprises, viewed along the frame middle line 18a, a plurality of, in particular at least ten, frame cross sections 20a, 22a, which are offset in the direction of the frame middle line 18a and are arranged perpendicularly to the frame middle line 18a.

The frame section 16a is arranged in a region of the frame unit 12a that differs from a corner region. In the present case the frame section 16a is entirely arranged in at least one of the side frame elements 24a, 26a. The frame section 16a thus corresponds to a frame section that is embodied as a hollow profile. The frame section 16a is herein arranged in a region of the frame unit 12a that is near a bottom. The frame section 16a has a vertical extension length, in particular an extension in the vertical direction 40a, that is equivalent to maximally 40%, advantageously no more than 30% and particularly preferably no more than 20% of the vertical extension length of the frame unit 12a. The frame section 16a is furthermore embodied in a one-part implementation. The frame section 16a is thus in particular implemented to be inseparable.

Viewed at least in a direction that is parallel to a main extension plane of the separating unit accommodation region 14a and in particular parallel to a bottom of the vehicle 10a, the frame section 16a furthermore has a course that differs from a straight course. The frame section 16a is herein implemented in a curved and/or bent fashion and in particular features at least one frame curvature and/or frame bend. Alternatively it is conceivable that a frame unit is at least substantially free of substantially differing frame cross sections or has, at least in a direction that is parallel to a main extension plane of a separating unit accommodation region and in particular parallel to a bottom of a vehicle, a straight course.

FIGS. 5 and 6 show the at least two substantially different frame cross sections 20a, 22a. The frame cross sections 20a, 22a have a same outer shape and/or outer contour. The frame cross sections 20a, 22a have in the present case an at least substantially elliptic outer shape and/or outer contour. The frame cross sections 20a, 22a have in the present case substantially different outer diameters. Moreover the frame cross sections 20a, 22a respectively have a central recess. Herein the frame cross sections 20a, 22a have a same inner shape and/or inner contour. The frame cross sections 20a, 22a have in the present case an at least substantially elliptic inner shape and/or inner contour. The frame cross sections 20a, 22a have in the present case substantially different inner diameters. Beyond this the frame cross sections 20a, 22a have in the present case substantially different maximum wall thicknesses. Alternatively frame cross sections could have any other outer shape and/or outer contour and/or inner shape and/or inner contour, e.g. circle-shaped, angular and/or star-shaped. In particular, an outer shape and/or outer contour could also differ from an inner shape and/or inner contour. It is also conceivable that frame cross sections have the same outer diameter, inner diameter and/or the same maximum wall thickness.

A first frame cross section 20a of the frame cross sections 20a, 22a has in the present case an outer diameter of approximately 70 mm. A maximum first extension length of the first frame cross section 20a, in particular in the direction of an, in particular hypothetical, semi-major axis, is therefore approximately 70 mm. A maximum second extension length of the first frame cross section 20a, in particular in the direction of an, in particular hypothetical, semi-minor axis, is approximately 30 mm. The first frame cross section 20a has in the present case an inner diameter of approximately 18 mm. A wall thickness of the first frame cross section 20a is at least substantially constant. A wall thickness of the first frame cross section 20a is approximately 6 mm.

A second frame cross section 22a of the frame cross sections 20a, 22a has in the present case an outer diameter of approximately 130 mm. A maximum first extension length of the second frame cross section 22a, in particular in the direction of an, in particular hypothetical, semi-major axis, is therefore approximately 130 mm. A maximum second extension length of the second frame cross section 22a, in particular in the direction of an, in particular hypothetical, semi-minor axis, is approximately 30 mm. Moreover the second frame cross section 22a has in the present case an inner diameter of approximately 14 mm. A wall thickness of the second frame cross section 22a is at least substantially constant. A wall thickness of the second frame cross section 22a is approximately 8 mm.

The frame cross sections 20a, 22a thus differ from one another, in at least one extension length, by a length portion of at least 20%. In this context it may also be noted that all values and/or dimensions given here merely describe a possible exemplary embodiment of the separating wall device but are not to be considered to have a restricting function.

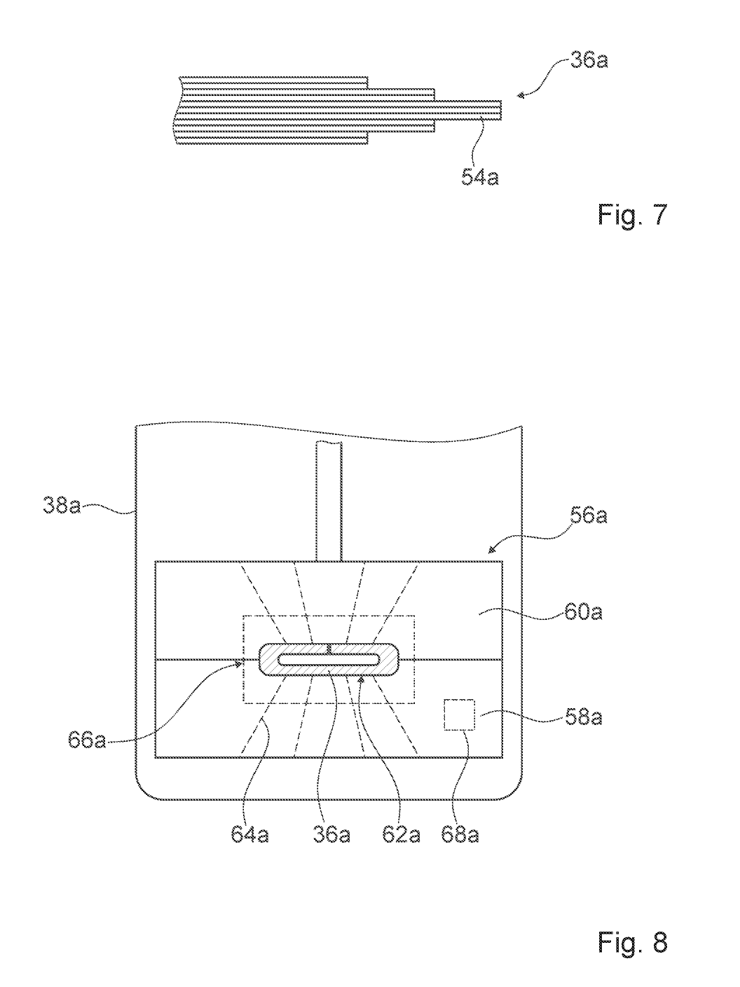

FIGS. 7 and 8 furthermore show an exemplary method for producing the separating wall device, in particular the frame unit 12a, by means of a separating wall device production apparatus.

FIG. 7 shows a portion of a pre-product 36a of the frame unit 12a in a lateral view. The pre-product 36a comprises a plurality of material layers 54a. The material layers 54a are equivalent to layers of synthetic material. The material layers 54a are in the present case implemented of glass fiber fabrics impregnated with a synthetic resin, so-called “pre-pregs”. The material layers 54a are arranged one above the other one. The material layers 54a are in the present case arranged offset one above the other one. Depending on a desired wall thickness of the frame unit 12a that is to be produced, and/or for an adjustment of a wall thickness of the frame unit 12a that is to be produced, a differing number of material layers 54a are herein arranged one above the other one, in particular in a layered fashion. Alternatively or additionally it is conceivable to arrange aluminum layers or the like between layers of synthetic material, resulting in particular in a further improved stability. It is further conceivable to additionally introduce glue materials and/or glue resins between the material layers.

FIG. 8 shows an exemplary separating wall device production apparatus in a schematic representation.

The separating wall device production apparatus comprises a container 38a. The container 38a is implemented as a pressure container, in the present case in particular as an autoclave.

The separating wall device production apparatus further comprises at least one form tool 56a, which is in particular arranged and/or arrangeable in the container 38a. The form tool 56a comprises a first form tool part 58a and a second form tool part 60a which is separable from the first form tool part 58a, in particular for opening the form tool 56a. The form tool 56a comprises a cavity 62a, which is arranged between the form tool parts 58a, 60a, for an accommodation of the pre-product 36a. The cavity 62a herein corresponds to a negative shape of the frame unit 12a that is to be produced, and/or of a frame section of the frame unit 12a that is to be produced, advantageously the frame section 16a.

Beyond this the form tool 56a comprises at least one vacuum channel 64a. The at least one vacuum channel 64a has a connection to the cavity 62a. The at least one vacuum channel 64a herein serves for suctioning and/or for a fixation of the pre-product 36a in the cavity 62a.

The form tool 56a moreover comprises a tempering unit 66a. The tempering unit 66a has a thermal connection with the cavity 62a. The tempering unit 66a is configured for a heating and/or cooling of the pre-product 36a. In the present case the tempering unit 66a is configured for a pre-tempering of the pre-product 36a. The tempering unit 66a may herein be implemented as any type of tempering unit, e.g. as an electric thermal resistor and/or as a fluid channel.

The form tool 56a further comprises an overpressure unit 68a. The overpressure unit 68a has an operative connection with the cavity 62a. The overpressure unit 68a is configured for applying a pressure of at least 4 bar, advantageously at least 5 bar, to the pre-product 36a, in particular to a hollow inner space of the pre-product 36a.

The method for producing the frame unit 12a corresponds at least partially to a vulcanization procedure. The pre-product 36a is herein laid into the cavity 62a for a forming process. Then the pre-product 36a is fixated in the cavity 62a by means of a negative pressure. In a following step an overpressure of up to 5 bar is generated in the interior of the cavity 62a. In addition, a temperature of the pre-product 36a is increased, by means of the tempering unit 66a, to 30° C.-60° C., in the present case in particular 40° C., as a result of which the pre-product 36a in particular becomes pliant and/or gluey, and is advantageously easily inlayable into the cavity 62a. A temperature in the container 38a is then increased to approximately 130°, in particular for the purpose of a vulcanization and/or hardening of the pre-product 36a. Following a cooling and a lowering of the pressure, advantageously via the overpressure unit 68a, it is possible to retrieve the pre-product 36a and/or the produced portion of the frame unit 12a from the form tool 56a and to assemble them/it to implement the frame unit 12a. Alternatively a heating of a pre-product, in particular to a temperature exceeding 100° C., could also be effected directly by means of a tempering unit. Moreover, a pre-heating of the pre-product could principally as well be dispensed with. It is further conceivable to produce a frame unit by way of a sandwich construction, in particular as a honeycomb plate by way of a honey comb construction, advantageously a honeycomb pre-preg construction, and/or by way of a flexible-tube construction as has been described, for example, in document DE 1 756 810 A1.

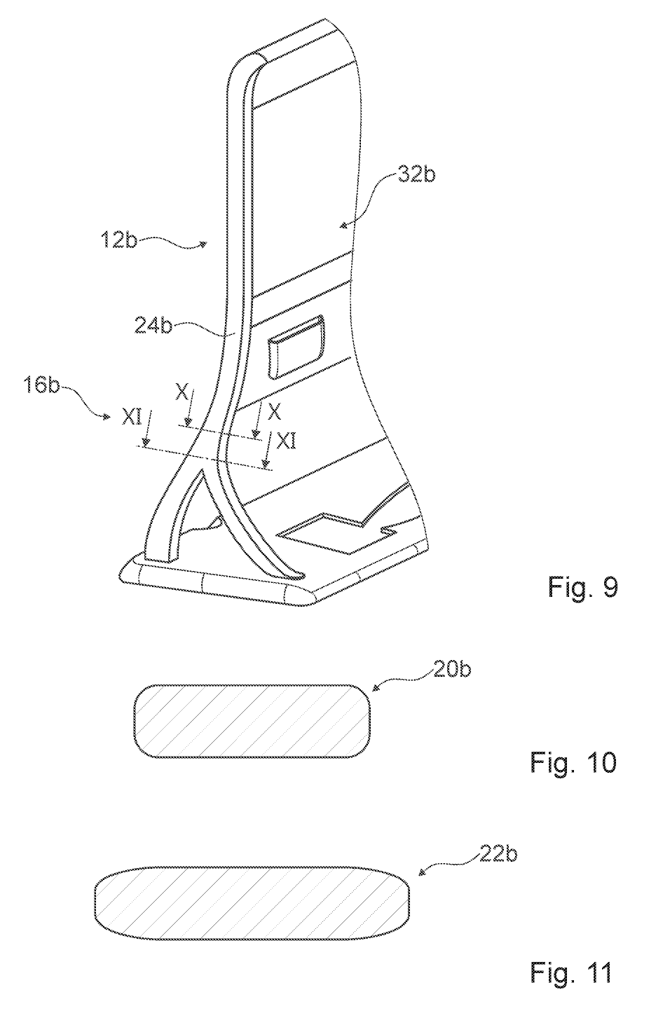

In FIGS. 9 to 19 further exemplary embodiments are shown. The following description and the drawings are substantially limited to the differences between the exemplary embodiments, wherein regarding identically denominated structural components, in particular regarding structural components having the same reference numeral, the drawings and/or the description of the other exemplary embodiments, in particular of FIGS. 1 to 8, may principally be referred to as well. To distinguish the exemplary embodiments, the letter a has been added to the reference numerals of the exemplary embodiment of FIGS. 1 to 8. In the exemplary embodiments of FIGS. 9 to 19, the letter a has been substituted by the letters b to f.

FIGS. 9 to 11 show a further exemplary embodiment of the invention. In the exemplary embodiment of FIGS. 9 to 11 the letter b has been added. The further exemplary embodiment of FIGS. 9 to 11 differs from the preceding exemplary embodiment at least substantially by an implementation of a frame unit 12b.

In the present case the frame unit 12b, in particular at least one frame section 16b of the frame unit 12b, which is arranged in a side frame element 24b, is embodied as a full profile and in particular has a multi-layer structure.

Analogously to the preceding exemplary embodiment, FIGS. 10 and 11 show at least two substantially different frame cross sections 20b, 22b of the frame section 16b. The frame cross sections 20b, 22b herein have substantially different outer diameters. Herein a longitudinal extension and a transverse extension of the frame cross sections 20b, 22b vary. Moreover the frame cross sections 20b, 22b have at least substantially different material thicknesses. Alternatively, a longitudinal extension or a transverse extension of frame cross sections could also be at least substantially identical.

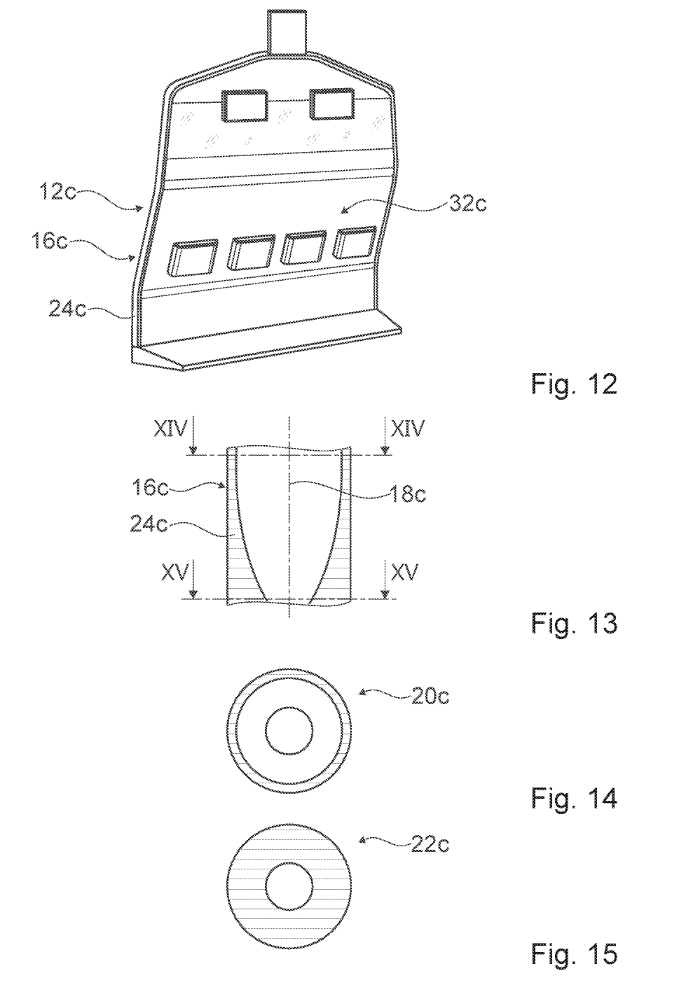

FIGS. 12 to 15 show a further exemplary embodiment of the invention. In the exemplary embodiment of FIGS. 12 to 15 the letter c has been added. The further exemplary embodiment of FIGS. 12 to 15 differs from the preceding exemplary embodiments at least substantially by an implementation of a frame unit 12c.

In the present case the frame unit 12c, in particular at least one frame section 16c of the frame unit 12c, which is arranged in a side frame element 24c, is embodied as a hollow profile. The frame unit 12c is implemented, in particular entirely, in a one-part implementation. The frame unit 12c is herein implemented, at least to a large extent, of a fiber composite material, in particular a synthetic fiber composite material.

FIGS. 13 to 15 show at least two substantially different frame cross sections 20c, 22c of the frame section 16c. The frame cross sections 20c, 22c have in the present case an at least substantially circular outer shape and/or outer contour. The frame cross sections 20c, 22c herein have at least substantially identical outer diameters. Alternatively, however, an outer diameter of frame cross sections could as well be variable.

The frame cross sections 20c, 22c moreover have an at least substantially circular inner shape and/or inner contour. In the present case the frame cross sections 20c, 22c have substantially differing inner diameters. The frame cross sections 20c, 22c further have, in the present case, substantially differing maximum wall thicknesses.

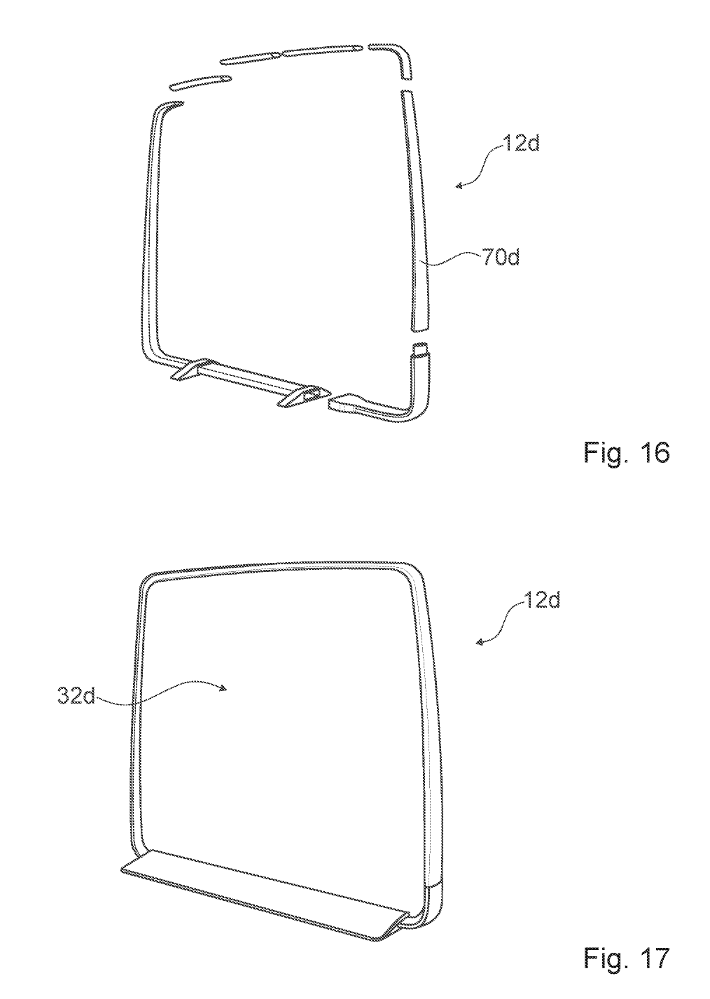

In FIGS. 16 and 17 a further exemplary embodiment of the invention is shown. In the exemplary embodiment of FIGS. 16 and 17 the letter d has been added. The further exemplary embodiment of FIGS. 16 and 17 differs from the preceding exemplary embodiments at least substantially by an implementation of a frame unit 12d.

The frame unit 12d has in this case a modular structure and comprises a plurality of frame elements 70d, which are in particular capable of being plugged together, wherein only one of the frame elements 70d has been given a reference numeral in FIG. 16. The frame elements 70d may herein feature different lengths, diameters and/or angle contours.

Furthermore a separating unit 32d is in the present case implemented as a wall element.

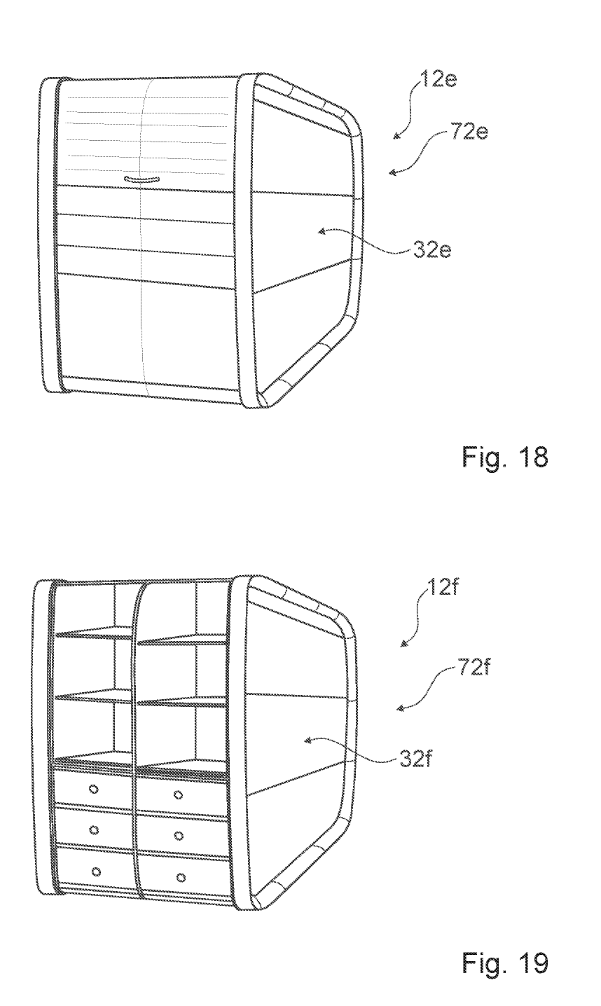

FIG. 18 shows a further exemplary embodiment of the invention. In the exemplary embodiment of FIG. 18 the letter e has been added. The further exemplary embodiment of FIG. 18 differs from the preceding exemplary embodiments at least substantially by a usage of a separating wall device.

FIG. 18 shows a stowage space unit 72e, which is implemented as a cupboard and/or stowage, with two separating wall devices which are arranged in parallel to one another.

Herein each of the separating wall devices comprises at least one frame unit 12e and a separating unit 32e, wherein in particular, for a better overview, only one of the separating wall devices has been given a reference numeral in FIG. 18.

The separating wall devices are herein arranged and interconnected in such a way that a stowage space, in the present case a closed stowage space, is created between the separating wall devices.

FIG. 19 shows another exemplary embodiment of the invention. In the exemplary embodiment of FIG. 19 the letter f has been added. The further exemplary embodiment of FIG. 19 differs from the preceding exemplary embodiments at least substantially by a usage of a separating wall device.

FIG. 19 shows a stowage space unit 72f, which is implemented as a cupboard and/or stowage, with two separating wall devices which are arranged in parallel to one another.

Each of the separating wall devices herein comprises at least one frame unit 12f as well as a separating unit 32f, wherein in particular, for the sake of a better overview, only one of the separating wall devices has been given a reference numeral in FIG. 19.

The separating wall devices are herein arranged and interconnected in such a way that a stowage space, in the present case a partially open stowage space, is created between the separating wall devices.

1. A separating wall device, in particular for a vehicle, with at least one frame unit defining, at least in a mounted state, at least one separating unit accommodation region, and comprising at least one frame section, wherein, viewed along a frame middle line that extends in the frame section and along the frame section, the frame section has at least two frame cross sections, which are substantially different from each other.

2. The separating wall device according to claim 1, wherein the frame cross sections have substantially different outer diameters.

3. The separating wall device according to claim 1, wherein the frame cross sections have substantially different inner diameters.

4. The separating wall device according to claim 1, wherein the frame cross sections have substantially different maximum wall thicknesses.

5. The separating wall device according claim 1, wherein, viewed at least in a direction that is parallel to a main extension plane of the separating unit accommodation region, the frame section has a course that differs from a straight course.

6. The separating wall device according to claim 1, wherein the frame section is embodied in a one-part implementation.

7. The separating wall device according to claim 1, wherein the frame unit comprises at least one side frame element, which is in a mounted state arranged at least substantially vertically, and comprises at least one transverse frame element, which is arranged at least substantially perpendicularly to the side frame element, wherein the frame section is arranged in the side frame element.

8. The separating wall device according to claim 1, wherein the frame section is in a mounted state arranged in a region of the frame unit that is near a bottom.

9. The separating wall device according to claim 1, further comprising at least one separating unit, which is arranged in the separating unit accommodation region, wherein the frame unit is configured to absorb at least a large portion of a weight force of the separating unit.

10. The separating wall device according to claim 9, wherein the frame unit comprises, on a side facing towards the separating unit, at least one fixation unit, which is configured at least for a form-fit fixation of the separating unit.

11. The separating wall device according to claim 9, wherein a vertical extension length of the separating unit is in the mounted state equivalent to at least 30% and/or maximally 95% of a vertical extension length of the frame unit.

12. The separating wall device according to claim 9, wherein the separating unit is embodied at least substantially dimensionally stable.

13. A vehicle, in particular aircraft, with at least one separating wall device according to claim 1.

14. A method for producing a separating wall device, in particular according to claim 1, wherein the separating wall device comprises at least one frame unit defining, at least in a mounted state, at least one separating unit accommodation region, and comprising at least one frame section, wherein, viewed along a frame middle line that extends in the frame section and along the frame section, the frame section has at least two frame cross sections, which are implemented substantially differently from each other.

15. The method according to claim 14, wherein, for a shaping of the frame unit, an overpressure is applied at least to a portion of a pre-product of the frame unit in a container, said portion of or entire pre-product being heated in the container.

16. A separating wall device, in particular for a vehicle, with at least one frame unit defining, at least in a mounted state, at least one separating unit accommodation region, and comprising at least one frame section, wherein, viewed at least in a direction that is parallel to a main extension plane of the separating unit accommodation region, the frame section has a course that differs from a straight course.

17. The separating wall device according to claim 16, wherein the frame section is embodied in a one-part implementation.

18. The separating wall device according to claim 16, wherein the frame unit comprises at least one side frame element, which is in a mounted state arranged at least substantially vertically, and comprises at least one transverse frame element, which is arranged at least substantially perpendicularly to the side frame element, wherein the frame section is arranged in the side frame element.

19. The separating wall device according to claim 16, wherein the frame section is in a mounted state arranged in a region of the frame unit that is near a bottom.

20. The separating wall device according to claim 16, further comprising at least one separating unit, which is arranged in the separating unit accommodation region, wherein the frame unit is configured to absorb at least a large portion of a weight force of the separating unit.

21. The separating wall device according to claim 20, wherein the frame unit comprises, on a side facing towards the separating unit, at least one fixation unit, which is configured at least for a form-fit fixation of the separating unit.

22. The separating wall device according to claim 20, wherein a vertical extension length of the separating unit is in the mounted state equivalent to at least 30% and/or maximally 95% of a vertical extension length of the frame unit.

23. The separating wall device according to claim 20, wherein the separating unit is embodied at least substantially dimensionally stable.
